(19) United States
(12) Patent Application Publication
(10) Pub. No.: US 2018/0058396 A1
(43) Pub. Date: Mar. 1, 2018

(54) AIR CLEANER

(71) Applicant: TOYOTA BOSHOKU KABUSHIKI KAISHA, Aichi-ken (JP)

(72) Inventors: Ryusuke KIMURA, Ichinomiya-shi (JP); Yoshinori INUZUKA, Nishio-shi (JP)

(73) Assignee: TOYOTA BOSHOKU KABUSHIKI KAISHA, Aichi-ken (JP)

(21) Appl. No.: 15/663,105

(22) Filed: Jul. 28, 2017

(30) Foreign Application Priority Data
Aug. 29, 2016 (JP) 2016-167243

(51) Int. Cl. F02M 35/024; F02M 35/02; F02M 35/08

(52) U.S. Cl. CPC F02M 35/02466; F02M 35/084; F02M 35/0209; F02M 35/02475

(57) ABSTRACT

An air cleaner has a first housing having an inlet and an upper opening, a second housing having an outlet and a lower opening, a filter element arranged between the upper opening of the first housing and the lower opening of the second housing. The first housing includes a looped wall, which protrudes from the inner surface thereof, and a vibrating body, which is made of a non-air permeable material and fixed to the upper end of the looped wall. Inside the first housing, an air chamber is defined by the inner surface of the bottom wall, the inner peripheral surface of the looped wall, and the lower surface of the vibrating body.

### BACKGROUND OF THE INVENTION

The present invention relates to an air cleaner for filtering air supplied to an internal combustion engine.

An air cleaner for an internal combustion engine has a first housing having an inlet and an opening, a second housing having an outlet and an opening, a filter element arranged between the opening of the first housing and the opening of the second housing.

In the air cleaner described in Japanese Laid-Open Patent Publication No. 2000-110682, a sound absorbing member made of a porous material such as foamed plastic is fixed to the inner surface of the first housing. The sound absorbing member reduces the intake noise.

The present inventors have discovered that, in the air cleaner of an internal combustion engine, the sound pressure level of low frequency components of 1 kHz or lower is greater than that of high frequency components higher than 1 kHz and that low frequency components are the main cause of the noise.

Although a conventional air cleaner having a sound absorbing member made of a porous material can reduce the sound pressure level of high frequency components higher than 1 kHz, such an air cleaner has difficulty in reducing the sound pressure level of low frequency components of 1 kHz or lower. That is, the conventional air cleaner cannot effectively reduce intake noise.

### SUMMARY OF THE INVENTION

An objective of the present invention is to provide an air cleaner capable of effectively reducing intake noise.

To achieve the foregoing objective and in accordance with one aspect of the present invention, an air cleaner is provided that includes a first housing including an inlet and an opening, a second housing including an outlet and an opening, and a filter element arranged between the opening of the first housing and the opening of the second housing. At least one of the first housing and the second housing includes a looped fixing rib, which protrudes from an inner surface thereof and a sheet-like or film-like vibrating body, which is made of a non-air permeable material and fixed to an upper end of the fixing rib. The inner surface of the at least one of the housings, an inner peripheral surface of the fixing rib, and the vibrating body define an air chamber.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing an air cleaner according to one embodiment;

FIG. 2 is a perspective view showing the first housing of the embodiment;

FIG. 3 is a perspective view of the vibrating body of the embodiment;

FIG. 4 is a perspective view of the first housing of the embodiment, illustrating a state in which the vibrating body is fixed;

FIG. 5 is a plan view of a first housing according to a modification; and

FIG. 6 is a plan view of a first housing according to another modification.

### DETAILED DESCRIPTION OF THE PREFERRED EMBODIMENTS

An air cleaner according to one embodiment will now be described.

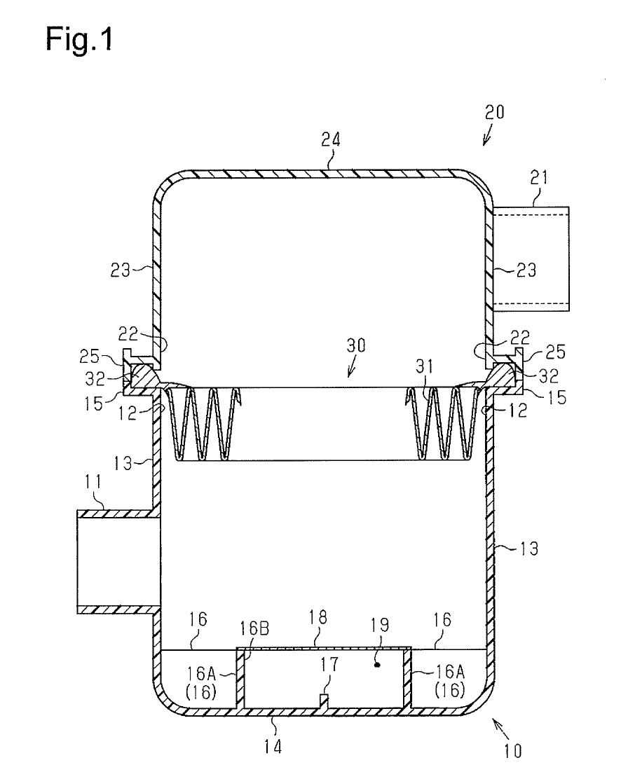

An air cleaner shown in FIG. 1 is arranged in an intake passage of a vehicle-mounted internal combustion engine and includes a first housing 10 having a cylindrical inlet 11 and a second housing 20 having a cylindrical outlet 21.

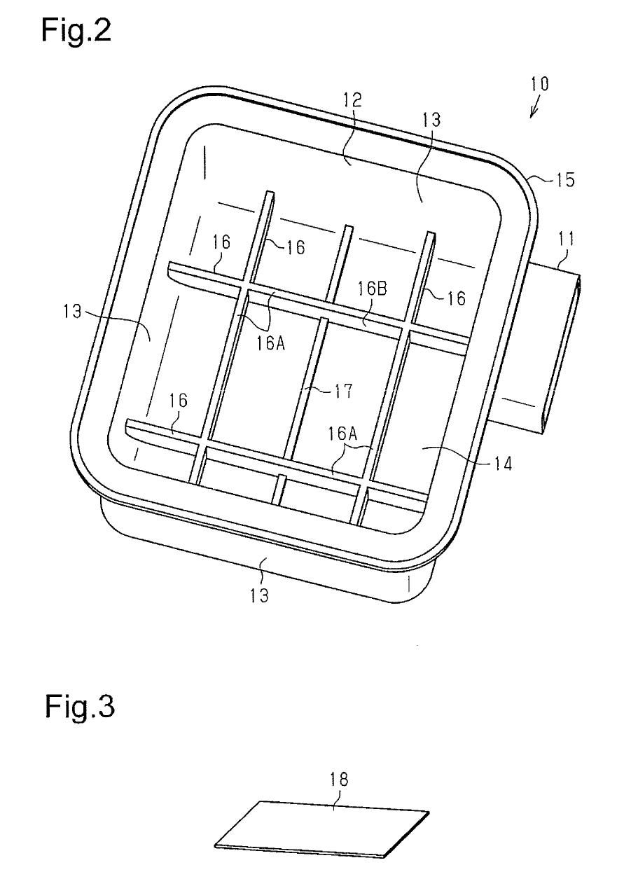

As shown in FIGS. 1 and 2, the first housing 10 includes an upper opening 12, a peripheral wall 13, which surrounds the upper opening 12, and a bottom wall 14. An outward extending flange 15 is provided around the entire periphery of the upper opening 12. The inlet 11 protrudes from the outer surface of the peripheral wall 13. The first housing 10 is made of a hard synthetic plastic.

As shown in FIG. 1, the second housing 20 includes a lower opening 22, a peripheral wall 23, which surrounds the lower opening 22, and a top wall 24. An outward extending flange 25 is provided around the entire periphery of the lower opening 22. The outlet 21 protrudes from the outer surface of the peripheral wall 23. The second housing 20 is made of a hard synthetic plastic.

A filter element 30 is arranged between the upper opening 12 of the first housing 10 and the lower opening 22 of the second housing 20. The filter element 30 has a filtration portion 31 and a loop-shaped sealing portion 32. The filtration portion 31 is formed by pleating a filtering medium sheet of filter paper or nonwoven fabric, and the sealing portion 32 is provided at the outer periphery of the filtration portion 31.

In the air cleaner, the sealing portion 32 of the filter element 30 is held by the flange 15 of the first housing 10 and the flange 25 of the second housing 20. The sealing portion 32 seals the gap between the first housing 10 and the second housing 20.

A vibration reducing structure for reducing intake noise is arranged on the bottom wall 14 of the first housing 10. The vibration reducing structure will now be described.

As shown in FIGS. 1 and 2, fixing ribs 16 and a reinforcing rib 17 protrude from the inner surface of the bottom wall 14 of the first housing 10. Two of the fixing ribs 16 are arranged in the longitudinal direction, and the other two are arranged in the transverse direction, so that a lattice pattern is formed on the entire bottom wall 14 of the first housing 10. The reinforcing rib 17 extends in parallel with and is located between two of the four fixing ribs 16 that are arranged side by side. The height of the reinforcing rib 17 (the amount of protrusion from the bottom wall 14) is set to be lower than the height of the fixing ribs 16.

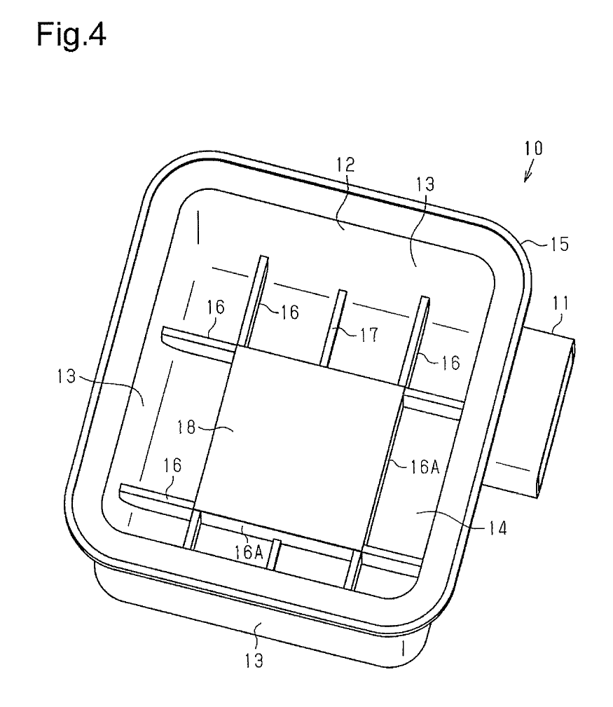

As shown in FIGS. 1 and 4, a film-like vibrating body 18 made of a non-air permeable material is fixed to the upper ends of the fixing ribs 16. As shown in FIG. 3, the vibrating body 18 has a rectangular shape in a plan view. The thickness of the vibrating body 18 is preferably several tens to several hundred micrometers. As shown in FIGS. 1 to 4, the fixing ribs 16 form a rectangular looped wall 16A with an upper opening 16B. The vibrating body 18 is provided to block the upper opening 16B. By providing the vibrating body 18, which has the above-described structure, an air chamber 19 (FIG. 1) is defined inside the first housing 10 by the inner surface of the bottom wall 14, the inner peripheral surface of the looped wall 16A, and the lower surface of the vibrating body 18.

In addition, the end of the looped wall 16A and the outer edge of the vibrating body 18 are fixed to each other by an adhesive over the entire circumference. Thereby, the gap between the upper end of the looped wall 16A and the outer edge of the vibrating body 18 is sealed over the entire circumference. In the air cleaner of the present embodiment, the vibrating body 18 does not contact the reinforcing rib 17.

Operation of the present embodiment will now be described.

When intake noise is generated by the operation of the internal combustion engine, the air in the air chamber 19 acts like a spring, so that the vibrating body 18 vibrates. The vibration of the vibrating body 18 and the vibration of the air in the air chamber 19 are reduced by being converted into thermal energy, which reduces the intake noise.

Various experiments and simulations performed by the present inventors have discovered that the vibration reducing structure constituted by the vibrating body 18 and the air chamber 19 allows the resonance frequency of the vibrating body 18 to be set to a value in a low frequency band (a frequency band of 1 kHz or lower in the present embodiment) and of effectively vibrating the vibrating body 18 at a low frequency component, thereby effectively reducing the sound pressure level of the same frequency component. From this, it can be said that the vibration reducing structure of the present embodiment is suitable for reducing the sound pressure level of low frequency components, which are the main cause of the intake noise.

Therefore, the air cleaner of the present embodiment, which employs such a vibration reducing structure, is capable of effectively reducing intake noise.

Also, in the air cleaner of the present embodiment, the gap between the upper end of the looped wall 16A and the outer edge of the vibrating body 18 is sealed over the entire circumference of the looped wall 16A. Therefore, when the vibrating body 18 vibrates due to the generation of intake noise, air is prevented from leaking from or entering into the air chamber 19. As a result, the vibrating body 18 easily vibrates, and the vibration is easily converted into thermal energy, so that the intake noise is effectively reduced.

Furthermore, the air cleaner of the present embodiment includes, in the air chamber 19, the reinforcing rib 17, which protrudes from the inner surface of the bottom wall 14 of the first housing 10 and has the upper end separated from the vibrating body 18. As a result, the vibration reducing structure, which is constituted by the fixing ribs 16 and the vibrating body 18, is provided on the inner surface of the first housing 10. Also, a reinforcing rib is arranged at the position of the vibration reducing structure so as not to interfere with the vibration of the vibrating body 18. Therefore, it is possible to prevent the stiffness of the first housing 10 from being reduced due to the disposition of the vibration reducing structure.

As described above, the present embodiment achieves the following advantages.

(1) The first housing 10 has the looped wall 16A, which protrudes from the inner surface of the bottom wall 14, and the vibrating body 18, which is fixed to the upper end of the looped wall 16A. The air chamber 19 is defined by the inner surface of the bottom wall 14, the inner peripheral surface of the looped wall 16A, and the vibrating body 18. This effectively reduces intake noise.

(2) The gap between the upper end of the looped wall 16A and the outer edge of the vibrating body 18 is sealed over the entire circumference of the looped wall 16A. As a result, the vibrating body 18 easily vibrates, and the vibration is easily converted into thermal energy, so that the intake noise is effectively reduced.

(3) The reinforcing rib 17, which is provided in the air chamber 19, protrudes from the inner surface of the bottom wall 14 of the first housing 10 and has an upper end separated from the vibrating body 18. Therefore, it is possible to prevent the stiffness of the first housing 10 from being reduced due to the disposition of the vibration reducing structure.

<Modifications>

The above illustrated embodiment may be modified as follows.

The upper end of the looped wall 16A and the outer edge of the vibrating body 18 may be fixed by welding.

The reinforcing rib 17 may be omitted. In addition, portions other than the looped wall 16A may be omitted from the fixing ribs 16.

Part of the gap between the upper end of the looped wall 16A and the outer edge of the vibrating body 18 does not necessarily need to be sealed.

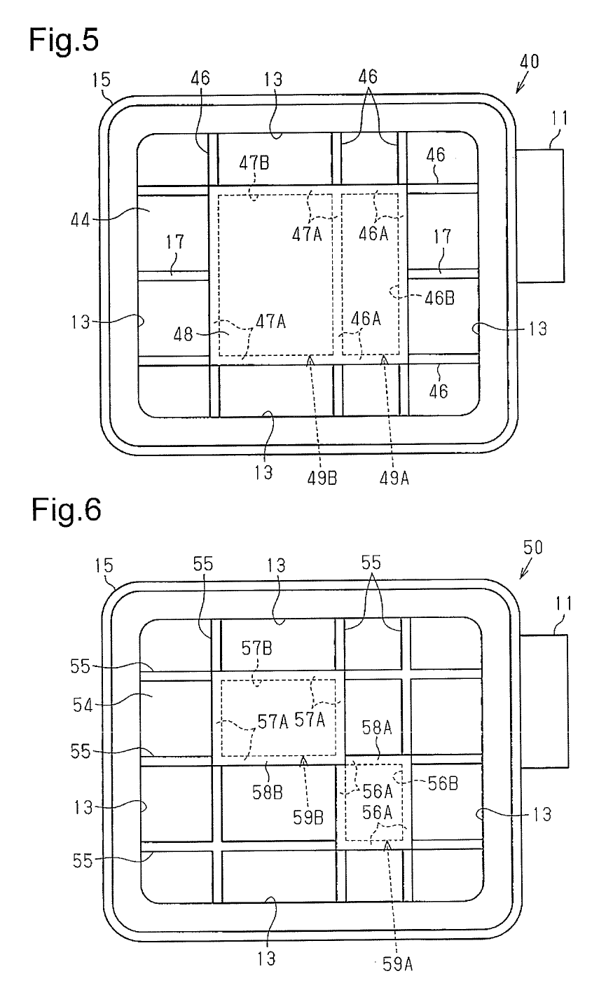

Two or more air chambers equivalent to the air chamber 19 may be provided in the air cleaner. In this case, the air chambers may have different volumes. When the volume of an air chamber is changed, the frequency at which the vibrating body resonates changes. Thus, the frequency components the sound pressure level of which can be effectively reduced also change. Specifically, if the other conditions are the same, the larger the volume of the air chamber, the lower becomes the resonance frequency of the vibrating body. Accordingly, the frequency components the sound pressure level of which can be effectively reduced become lower frequency components. Therefore, by providing air chambers having different volumes like the air cleaner described above, it is possible to effectively reduce the sound pressure levels of different frequency components, respectively, so that the intake noise is more effectively reduced. Specific examples of such an air cleaner are shown in FIGS. 5 and 6.

In the modification shown in FIG. 5, a total of five fixing ribs 46, three in the longitudinal direction and two in the transverse direction, which extend at different intervals, are arranged in a lattice pattern on the inner surface of a bottom wall 44 of a first housing 40. This provides multiple portions that form rectangular loops (looped walls) with the fixing ribs 46 on the bottom wall 44 of the first housing 40. The looped walls include two looped walls 46A, 47A, which are adjacent to each other and have different opening areas. Upper openings 46B, 47B of the two looped walls 46A, 47A are blocked by a single vibrating body 48. The first housing 40 thus has a first air chamber 49A, which is defined by the inner surface of the bottom wall 44, the inner surface of the looped wall 46A, and the vibrating body 48, and a second air chamber 49B, which is defined by the inner surface of the bottom wall 44, the inner surface of the looped wall 47A, and the vibrating body 48. In this air cleaner, the volume of the first air chamber 49A is set smaller than the volume of the second air chamber 49B.

In the modification shown in FIG. 6, a total of six fixing ribs 55, three in the longitudinal direction and three in the transverse direction, which extend at different intervals, are arranged in a lattice pattern on the inner surface of a bottom wall 54 of a first housing 50. This provides multiple portions that form rectangular loops (looped walls) with the fixing ribs 55 on the bottom wall 54 of the first housing 50. The looped walls include two looped walls 56A, 57A, which have different opening areas. Upper openings 56B, 57B of the two looped walls 56A, 57A are blocked by two vibrating bodies 58A, 58B. The first housing 50 thus has a first air chamber 59A, which is defined by the inner surface of the bottom wall 54, the inner surface of the looped wall 56A, and the vibrating body 58A, and a second air chamber 59B, which is defined by the inner surface of the bottom wall 54, the inner surface of the looped wall 57A, and the vibrating body 58B. In this air cleaner, the volume of the first air chamber 59A is set smaller than the volume of the second air chamber 59B.

The vibrating body 18 may be a film made of a synthetic plastic other than polypropylene (for example, polyethylene terephthalate). The vibrating body 18 may also be a film made of synthetic rubber. Further, instead of such a plastic film or a rubber film, a sheet-like and non-air permeable vibrating body made of a soft synthetic plastic or synthetic rubber may be provided to block the upper opening 16B of the looped wall 16A.

The vibration reducing structure may be arranged on the peripheral wall 13 of the first housing 10 or on the peripheral wall 23 and the top wall 24 of the second housing 20.

1. An air cleaner comprising:
a first housing including an inlet and an opening;
a second housing including an outlet and an opening; and
a filter element arranged between the opening of the first housing and the opening of the second housing, wherein
at least one of the first housing and the second housing includes
a looped fixing rib, which protrudes from an inner surface thereof, and
a sheet-like or film-like vibrating body, which is made of a non-air permeable material and fixed to an upper end of the fixing rib, and
the inner surface of the at least one of the housings, an inner peripheral surface of the fixing rib, and the vibrating body define an air chamber.

2. The air cleaner according to claim 1, wherein a gap between the upper end of the fixing rib and the vibrating body is sealed over an entire circumference of the fixing rib.

3. The air cleaner according to claim 1, wherein
the air chamber is a one of a plurality of air chambers, and the air chambers have different volumes.

4. The air cleaner according to claim 1, further comprising a reinforcing rib provided in the air chamber, wherein the reinforcing rib protrudes from the inner surface of the at least one of the housings and has an upper end that is separated from the vibrating body.

5. The air cleaner according to claim 1, wherein the vibrating body is made of a plastic film.
